(19) United States
(12) Patent Application Publication
(10) Pub. No.: US 2019/0225059 A1
(43) Pub. Date: Jul. 25, 2019

(54) MANUFACTURING METHOD OF ROLLER SHADE DEVICE AND ROLLER SHADE DEVICE

(71) Applicant: AISIN SEIKI KABUSHIKI KAISHA, Kariya-shi (JP)

(72) Inventor: Shinichi HIRAMATSU, Chiryu-shi (JP)

(73) Assignee: AISIN SEIKI KABUSHIKI KAISHA, Kariya-shi (JP)

(21) Appl. No.: 16/255,158

(22) Filed: Jan. 23, 2019

(30) Foreign Application Priority Data
Jan. 24, 2018 (JP) 2018-009785

(51) Int. Cl. B60J 1/20; B60J 7/00

(52) U.S. Cl. CPC B60J 1/2033; B60J 1/205; E06B 9/42; B60J 7/0015; B60J 1/2063

(57) ABSTRACT

A manufacturing method of a roller shade device including a fixed shaft, a winding cylinder which has flexibility, and within which the fixed shaft is inserted to be positioned so as to be rotatable therewith, a shade sheet, and a torsion spring applying a rotary force to the winding cylinder includes a process of inhibiting an axial end portion of the winding cylinder from rotating relative to the fixed shaft in a state where the torsion spring applies the rotary force to the winding cylinder, the axial end portion being away in an axial direction from a position where the torsion spring is connected to the winding cylinder, and a process of bonding the shade sheet to the winding cylinder in a state where the axial end portion is inhibited from rotating.

### CROSS REFERENCE TO RELATED APPLICATIONS

This application is based on and claims priority under 35 U.S.C. § 119 to Japanese Patent Application 2018-009785, filed on Jan. 24, 2018 the entire content of which is incorporated herein by reference.

### TECHNICAL FIELD

This disclosure generally relates to a manufacturing method of a roller shade device and the roller shade device.

### BACKGROUND DISCUSSION

A roller shade device winding up a shade sheet around a winding cylinder fitted onto a fixed shaft is formed such that the fixed shaft is curved to be formed in an arc shape by being matched with a curved shape of a translucent panel or a window glass which corresponds to a lighting portion. For example, according to EP2529965B (hereinafter referred to as Patent reference 1), a configuration in which a winding cylinder being formed in a corrugated structure in which a small-diameter portion and a large-diameter portion are continuously and alternately provided is disclosed. According to DE102013221558B (hereinafter referred to as Patent reference 2), plural cylindrical members are connected with one another in an axial direction to include a winding cylinder. That is, by including such a configuration, the winding cylinder may include flexibility in which the winding cylinder can rotate by following the curved shape of the fixed shaft. Then, accordingly, the shade sheet being extended from the winding cylinder may be disposed along the curved shape of the lighting portion.

However, according to the aforementioned conventional disclosure, the shade sheet may be wrinkled by twisting of the winding cylinder which includes flexibility. Accordingly, the designability may be decreased.

A need thus exists for a manufacturing method of a roller shade device and a roller shade device which are not susceptible to the drawback mentioned above.

### SUMMARY

According to an aspect of this disclosure, a manufacturing method of a roller shade device including a fixed shaft, a winding cylinder which has flexibility following a curved shape of the fixed shaft, and within which the fixed shaft is inserted to be positioned so as to be rotatable therewith, a shade sheet which is wound up around the winding cylinder, and a torsion spring applying a rotary force to the winding cylinder, the rotary force which winds up the shade sheet around the winding cylinder includes a process of inhibiting an axial end portion of the winding cylinder from rotating relative to the fixed shaft in a state where the torsion spring applies the rotary force to the winding cylinder, the axial end portion being away in an axial direction from a position where the torsion spring is connected to the winding cylinder, and a process of bonding the shade sheet to the winding cylinder in a state where the axial end portion is inhibited from rotating.

According to another aspect of this disclosure, a roller shade device includes a fixed shaft, a winding cylinder which has flexibility following a curved shape of the fixed shaft, and within which the fixed shaft is inserted to be positioned so as to be rotatable therewith, a shade sheet which is wound up around the winding cylinder, a torsion spring applying a rotary force to the winding cylinder, the rotary force which winds up the shade sheet around the winding cylinder, and a rotation prevention mechanism inhibiting an axial end portion of the winding cylinder from rotating relative to the fixed shaft in a state where the torsion spring applies the rotary force to the winding cylinder, the axial end portion being away in an axial direction from a position where the torsion spring is connected to the winding cylinder.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle including a lighting portion at a roof panel according to an embodiment disclosed here;

FIG. 2 is a perspective view of a roller shade device provided downwardly of the lighting portion (an extended state);

FIG. 3 is a perspective view of the roller shade device (a wound-up state);

FIG. 4 is an exploded perspective view of the roller shade device;

FIG. 5A is a cross sectional view taken along an axial direction of the roller shade device;

FIG. 5B is another cross sectional view taken along the axial direction of the roller shade device;

FIG. 6 is a perspective view of each of cylindrical members of a winding cylinder;

FIG. 7 is a flow chart showing a manufacturing method of the roller shade device;

FIG. 8 is a perspective view of an axial end portion which is provided with a rotation prevention mechanism;

FIG. 9 is a cross sectional view of the axial end portion which is provided with the rotation prevention mechanism;

FIG. 10 is a perspective view of the winding cylinder and a shade sheet which is configured to be attached to the winding cylinder, the winding cylinder in which the axial end portion is inhibited from rotating in a state where a torsion spring applies a rotary force in a winding-up direction;

FIG. 11A is a cross sectional view of a connection portion of the cylinder members of the winding cylinder in an unloaded state;

FIG. 11B is a cross sectional view of the connection portion of the cylinder members of the winding cylinder in a state where the rotary force is applied;

FIG. 12 is a cross sectional view of an axial end portion which is provided with a rotation prevention mechanism according to another example of the embodiment;

FIG. 13A is a perspective view of a winding cylinder of another example; and

FIG. 13B is a cross sectional view of the roller shade device which includes the winding cylinder of another example.

### DETAILED DESCRIPTION

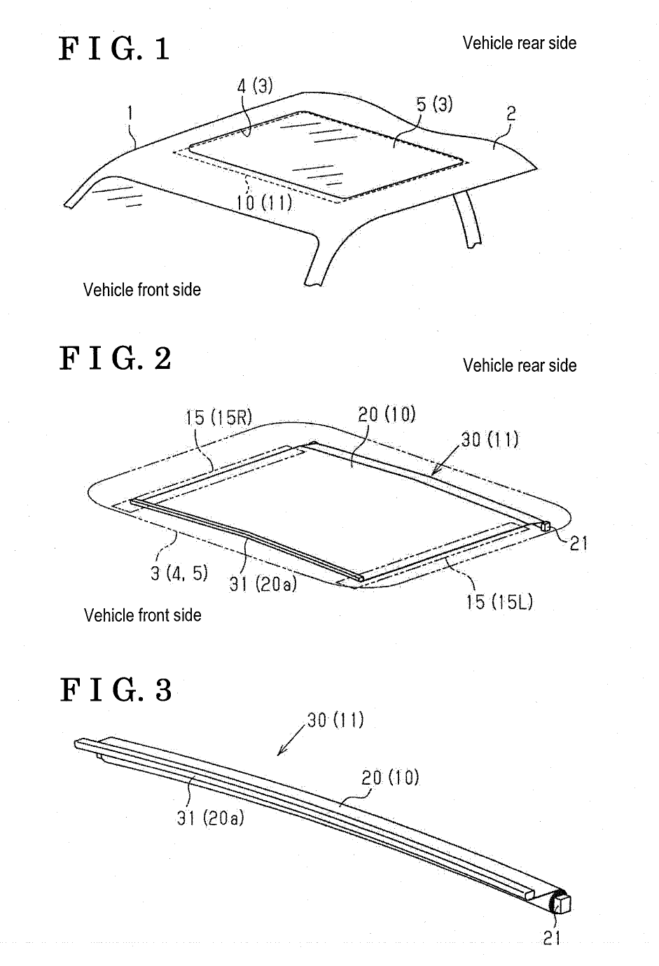

An embodiment of a roller shade device will hereunder be explained with reference to the drawings. As illustrated in FIG. 1, a roof panel 2 of a vehicle 1 includes a lighting portion 3. In the vehicle 1 of the embodiment, the lighting portion 3 is formed such that a translucent panel 5 which is made from a translucent material, for example, glass, is disposed at a substantially-quadrilateral-shaped roof-opening portion 4 provided at the roof panel 2. In the embodiment, the translucent panel 5 corresponds to a movable panel which may be opened and closed by a sunroof device. The vehicle 1 of the embodiment includes a sunshade device 11 in which a shading member 10 may be disposed downwardly of the roof opening portion 4 which is provided with the translucent panel 5.

Specifically, as illustrated in FIG. 2, in the vehicle 1 of the embodiment, a right-left pair of guide rails 15 (15L, 15R) extending in a vehicle front-rear direction is provided inside the roof opening portion 4 at circumferential rim portions provided at both sides thereof in a vehicle width direction. A winding device 21 winding the shading sheet 20 being made of fabric is provided inside the roof opening portion 4 at the circumferential rim portion of a vehicle rear portion. Accordingly, in the vehicle 1 of the embodiment, a roller shade device 30 including the shade sheet 20 being wound up by the winding device 21 is provided as the shading member 10.

As illustrated in FIGS. 2 to 4, the roller shade device 30 of the embodiment includes an operation member 31 which is formed in a longitudinal shape extending in the vehicle width direction and which is fixed to a first end (a distal end 20a) of the shade sheet 20. Sliding shoes 32 being slidably engaged with the right and left guide rails 15 extending in the vehicle front-rear direction are fixed at both end portions of the operation member 31 in a longitudinal direction thereof. In the roller shade device 30 of the embodiment, the operation member 31 operates in the vehicle front-rear direction, and thus the shade sheet 20 being wound up by the winding device 21 is extended downwardly of the roof opening portion 4 (the translucent panel 5) of the lighting portion 3, and the shade sheet 20 which is extended may be rewound up by the winding device 21.

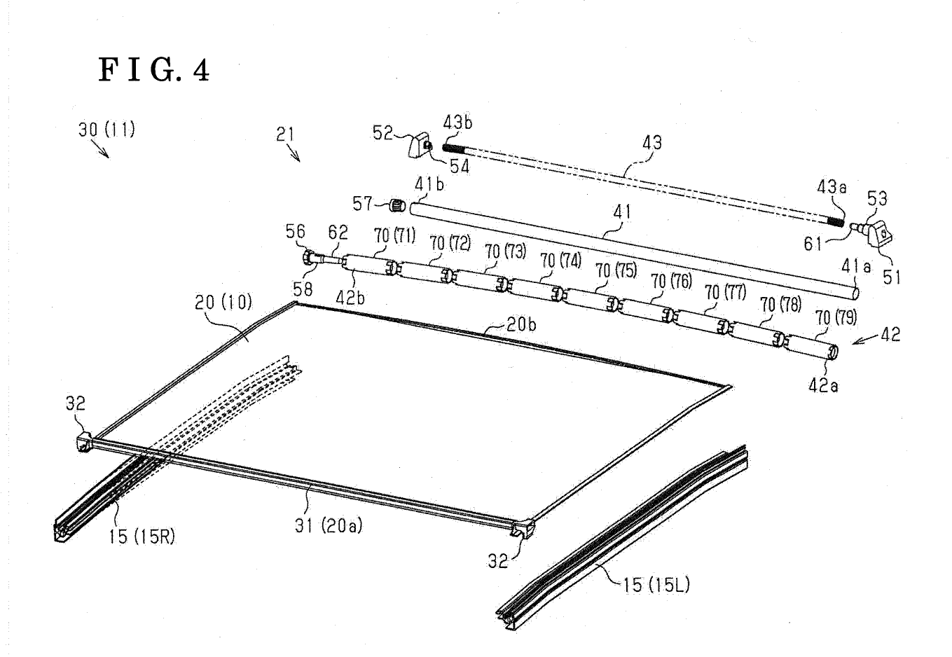

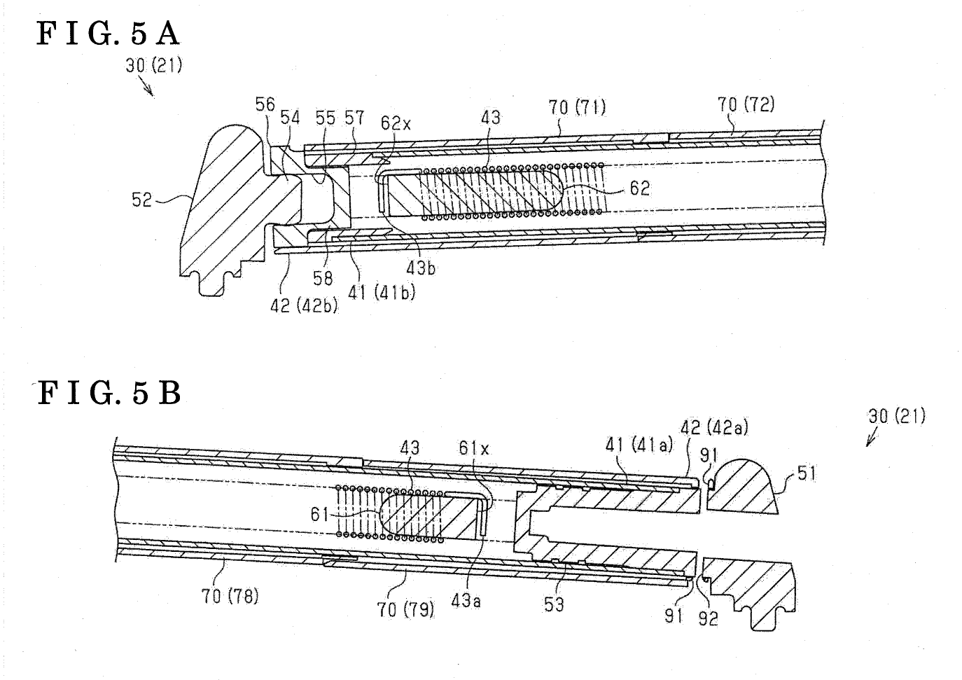

Specifically, as illustrated in FIGS. 4, 5A, and 5B, the roller shade device 30 of the embodiment includes a fixed shaft 41 being fixed rearwardly of the guide rail 15 in a state of being extended in the vehicle width direction, and a winding cylinder 42 rotatably fitted onto the fixed shaft 41. The roller shade device 30 includes a torsion spring (a torsion coil spring) 43 applying a rotary force to the winding cylinder 42. The roller shade device 30 of the embodiment is provided with the winding device 21 by attaching of a base end 20b of the shade sheet 20 to an outer circumference of the winding cylinder 42.

According to the roller shade device 30 of the embodiment, the fixed shaft 41 is provided such that an axial end portion 41a which is disposed at the left in the vehicle width direction (right in FIGS. 4, 5A and 5B) is unrotatably supported by a first support member 51 disposed at a rear of the guide rail 15L (see FIG. 2). The winding cylinder 42 is provided such that an axial end portion 42b disposed at the right in the vehicle width direction (left in FIGS. 4, 5A and 5B) is rotatably supported by a second support member 52 disposed at a rear of the guide rail 15R. The torsion spring 43 includes a first end portion 43a which is connected to the axial end portion 41a of the fixed shaft 41, and a second end portion 43b which is connected to the axial end portion 42b of the winding cylinder 42. The roller shade device 30 of the embodiment includes a configuration in which the winding cylinder 42 is applied with the rotary force winding up the shade sheet 20 in response to an elastic force (an elastic restoring force) of the torsion spring 43.

Specifically, the fixed shaft 41 of the embodiment includes a cylindrical outer shape. As illustrated in FIG. 5B, the first support member 51 includes an insertion portion 53 formed in a shaft shape and being inserted into a cylinder of the fixed shaft 41 from the axial end portion 41a disposed at the left side in the vehicle width direction. The first support member 51 supports the axial end portion 41a of the fixed shaft 41 to be unrotatable in a state where the insertion portion 53 is fixed to an inner circumference of the fixed shaft 41.

Meanwhile, as illustrated in FIG. 5A, the second support member 52 includes an axial protrusion 54 protruding to the left side in the vehicle width direction (the right in FIG. 5A). The roller shade device 30 of the embodiment includes a connection member 56 including a recessed portion 55 into which the axial protrusion 54 is inserted. The winding cylinder 42 of the embodiment is provided such that the axial end portion 42b disposed at the right in the vehicle width direction is fixed with the connection member 56, and thus the axial end portion 42b is supported by the second supporting member 52 in a state where the winding cylinder 42 integrally rotates with the connection member 56.

The axial end portion 41b of the fixed shaft 41 disposed close to the second support member 52 is coaxially fixed with the cylindrical bearing member 57 by being inserted into the winding cylinder 42. The aforementioned connection member 56 includes a insertion portion 58 being inserted into the bearing member 57. The roller shade device 30 of the embodiment includes a configuration in which the axial end portion 41b of the fixed shaft 41 is stably supported at the right in the vehicle width direction (the left in FIGS. 4, 5A and 5B).

As illustrated in FIGS. 5A and 5B, in the roller shade device 30 of the embodiment, the torsion spring 43 extends along an axial line thereof inside the fixed shaft 41 which is formed in a cylindrical shape. The first support member 51 includes a shaft-shaped protrusion 61 onto which the first end portion 43a of the torsion spring 43 that is formed in a coil shape is fitted at the axial end portion 41a of the fixed shaft 41 being supported by the first support member 51. The aforementioned connection member 56 integrally rotating with the axial end portion 42b of the winding cylinder 42 in a state where the second support member 52 is supported includes an axial protrusion 62 onto which the second end portion 43b of the torsion spring 43 being formed in the coil shape is fitted. In the roller shade device 30 of the embodiment, the axial protrusions 61, 62 are provided so as to protrude in the axial direction from distal end portions of the insertion portions 53, 58 respectively provided at the first support member 51 and the connection member 56. The axial protrusions 61, 62 are respectively provided with lock holes 61x, 62x for locking the first end portion 43a and the second end portion 43b of the torsion spring 43, the first end portion 43a and the second end portion 43b which are fitted onto the outer circumferences of the axial protrusions 61, 62.

That is, in the roller shade device 30 of the embodiment, the torsion spring 43 includes a first end portion 43a which is locked by the axial protrusion 61 provided at the first support member 51 to be connected to the fixed shaft 41 via the first support member 51. The torsion spring 43 is configured such that the second end portion 43b is locked by the axial protrusion 62 disposed at the connection member 56, and thus is connected to the winding cylinder 42 via the connection member 56. The winding cylinder 42 of the embodiment rotates in response to the elastic force of the torsion spring 43 such that the torsion spring 43 drives the axial end portion 42b which is disposed at the right in the vehicle width direction and which is connected to the second end portion 43b of the torsion spring 43.

As illustrated in FIG. 4, in the roller shade device 30 of the embodiment, the fixed shaft 41 includes a curved shape to be formed in an arc shape so as to match the curved shape of the roof panel 2 which is provided with the roller shade device 30. In addition, the winding cylinder 42 of the embodiment includes plural cylindrical members 70 (71 to 79) that are connected with one another in the axial direction. The roller shade device 30 of the embodiment is configured such that the winding cylinder 42 includes the flexibility so as to be able to rotate while following the curved shape of the fixed shaft 41.

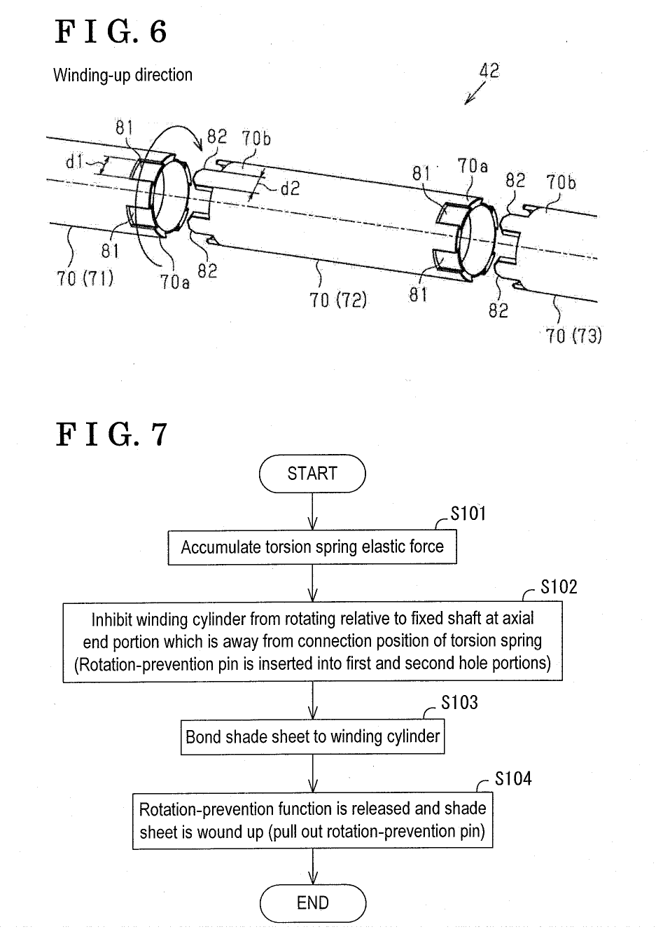

Specifically, as illustrated in FIG. 6, the roller shade device 30 of the embodiment includes plural engagement recessed portions 81 which are provided at the first axial end portions 70a disposed at the left in the vehicle-width direction (right in FIG. 6) in a state where the roof panel 2 is attached with the roller shade device 30. The cylindrical members 70 include plural engagement protrusions 82 provided at the second axial end portion 70b disposed at the right in the vehicle width direction (left in FIG. 6) in a state where the roof panel 2 is attached with the roller shade device 30.

Specifically, in the cylindrical members 70 of the embodiment, the engagement recessed portions 81 are equally spaced apart from one another in a circumferential direction so as to be cut out at the outer circumferential surface of the first axial end portion 70a. The engagement protrusions 82 are equally spaced apart from one another in the circumferential direction so as to protrude from the second axial end portion 70b in the axial direction. The engagement protrusions 82 are formed so as to include the outside dimension which is slightly smaller than the inner diameter of the engagement recessed portion 81. The roller shade device 30 of the embodiment is configured such that the engagement recessed portion 81 and the engagement protrusion 82 are engaged with each other between the cylindrical members that are next to each other in the axial direction, and thus the cylindrical members 70 disposed next to each other in the axial direction are connected with each other as the winding cylinder 42 which may transmit the rotary force and which may include a flexibility.

Next, a manufacturing method of the roller shade device 30 including the aforementioned configuration, specifically, an operation process when the shade sheet 20 is wound up by the winding cylinder 42 will hereunder be explained.

As illustrated in a flowchart in FIG. 7, in a manufacturing process of the roller shade device 30, the torsion spring 43 is elastically deformed by adding of torsion to the torsion spring 43 serving as a drive source in a case where the shade sheet 20 is wound up by the winding cylinder 42. Accordingly, the elastic force for applying the rotary force (See FIG. 6. Rotary force illustrated with an arrow in FIG. 6) for winding up of the shade sheet 20 around the winding cylinder 42 is accumulated (Step S101).

In the roller shade device 30 of the embodiment, the process for accumulating the elastic force of the torsion spring 43 is operated by rotation of the axial end portion 42b of the winding cylinder 42 opposite to the winding-up direction, the axial end portion 42b to which the second end portion 43b of the torsion spring 43 is connected, in a state where the axial end portion 41a of the fixed shaft 41 to which the first end portion 43a of the torsion spring 43 is connected is retained so as not to be rotatable.

Next, in a state where the torsion coil spring 43 applies the winding cylinder 42 the rotary force in response to the accumulated elastic force of the torsion spring 43, the axial end portion 42a of the winding cylinder 42 which is away in the axial direction from a position where the winding cylinder 42 is connected with the second end portion 43b is inhibited from rotating relatively against the fixed shaft 41 (Step S102).

By the operation of the rotation prevention process, the base end 20b of the shade sheet 20 is bonded to the winding cylinder 42 in a state where the axial end portion 42a is inhibited from rotating (Step S103), the axial end portion 42a which is disposed at the left in the vehicle-width direction which is opposite to the axial end portion 42b being disposed at the right in the vehicle-width direction, the axial end portion 42b to which the torsion spring 43 applies the rotary force. The roller shade device 30 of the embodiment is configured such that the winding cylinder 42 winds up the shade sheet 20 by releasing of the rotation prevention function of the winding cylinder 42 after bonding of the shade sheet 20 (Step S104).

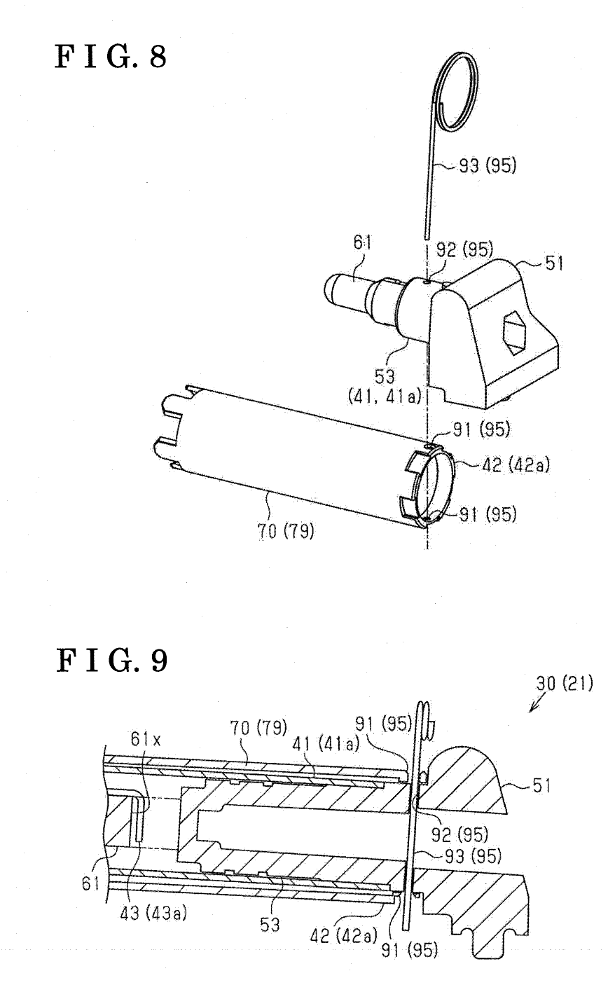

Specifically, as illustrated in FIGS. 8 and 9, in the roller shade device 30 of the embodiment, first hole portions 91 passing through the winding cylinder 42 in the radial direction are provided at the axial end portion 42a which is provided at the left in the vehicle width direction (right in FIGS. 8 and 9). In particular, the first hole portions 91 are provided at two positions opposing each other in the winding cylinder 42 in the radial direction. Second hole portions 92 passing through the insertion portion 53 of the first support member 51 which is integrally provided with the fixed shaft 41 is provided at the axial end portion 41a of the fixed shaft 41 which is disposed at the left in the vehicle width direction, the fixed shaft 41 onto which the winding cylinder 42 is fitted. The roller shade device 30 of the embodiment is configured such that, by insertion of a rotation-prevention pin 93 serving as a shaft-shaped member for the rotation prevention function relative to the first and second hole portions 91, 92, a rotation prevention mechanism 95 which may retain the axial end portion 42a of the winding cylinder 42 is provided, the axial end portion 42a being away from the position where the torsion spring 43 applies the rotary force in the axial direction so as to be relatively unrotatable.

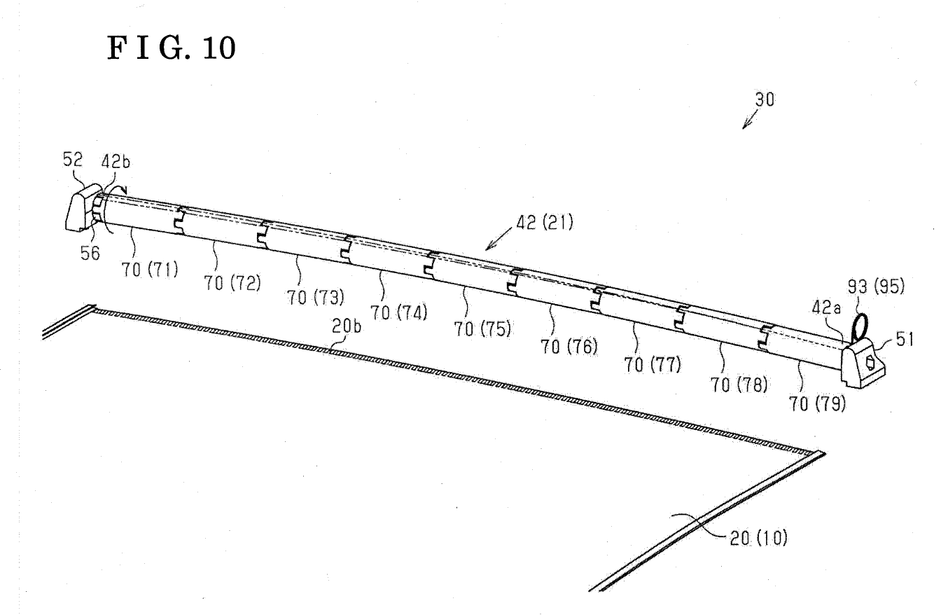

That is, as illustrated in FIG. 10, the shade sheet 20 is bonded to the winding cylinder 42 in a state where the rotation-prevention pin 93 is inserted into the first and second hole portions 91, 92 disposed at the left in the vehicle width direction in a mounted state on the vehicle 1 after the elastic force for applying the rotary force to the winding cylinder 42 to the torsion spring 43 is accumulated. The shade sheet 20 is bonded with, for example, a double-sided tape, and glue. The rotation-prevention pin 93 is pulled out from the first and second hole portions 91, 92 after the base end 20b of the shade sheet 20 is bonded to the winging cylinder 42, and thus the shade sheet 20 is wound up by the rotating winding cylinder 42 in response to the elastic force of the torsion spring 43.

Next, the action of the roller shade device 30 of the embodiment will be explained. As above, according to the roller shade device 30 of the embodiment, the winding cylinder 42 is provided such that the cylinder members 70 (71 to 79) including the plural engagement recessed portions 81 at the first axial end portion 70a and the plural engagement protrusions 82 at the second axial end portion 70b are connected with one another in the axial direction. The engagement recessed portion 81 and the engagement protrusion 82 connecting the cylinder members 70 with one another are formed such that the inner dimension of the engagement recessed portion 81 is slightly smaller than the outer dimension of the engagement protrusion 82, and thus the winding cylinder 42 of the cylinder member 70 may be applied with the flexibility which may rotate the winding cylinder 42 while following the curved shape of the fixed shaft 41.

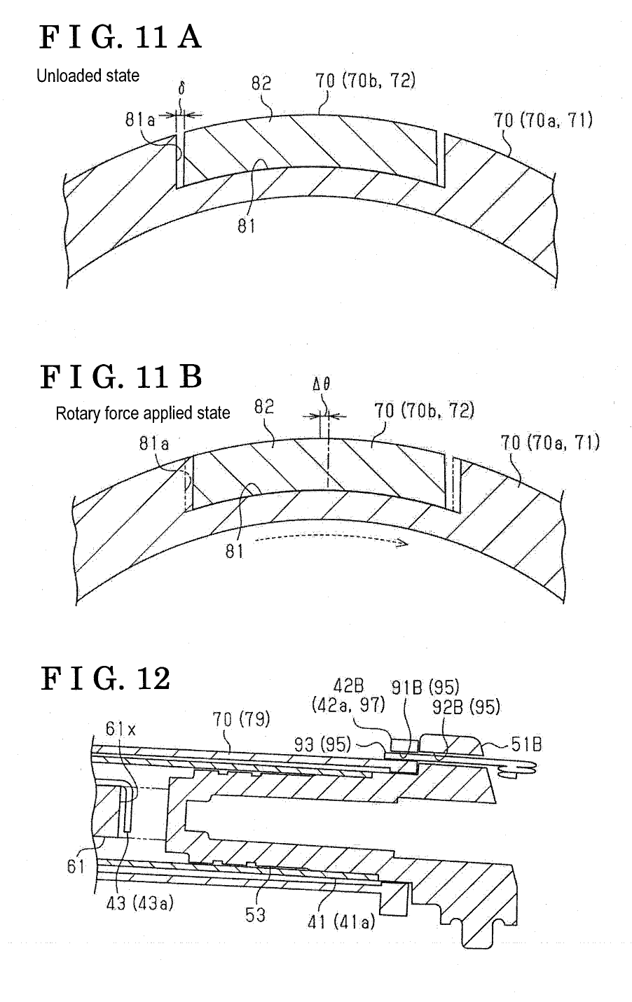

That is, as illustrated in FIG. 11A, in a state where the winding cylinder 42 is in the unloaded state, that is, the winding cylinder 42 is not applied with the rotary force in response to the elastic force of the torsion spring 43, a clearance δ may be provided between the engagement recessed portion 81 and the engagement protrusion 82 connecting the cylinder members 70 with one another in the circumferential direction based on the difference between the dimensions thereof. Accordingly, as illustrated in FIG. 11B, in a case where the winding cylinder 42 rotates, the cylinder members 70 which are disposed next to each other in the axial direction and which are disposed at an upper stream of a passage where the rotary force is transmitted in the axial direction rotates up to a position where the clearance δ provided between the engagement recessed portion 81 and the engagement protrusion 82 in the circumferential direction is closed. The winding cylinder 42 of the embodiment is configured such that a side wall 81a of the engagement protrusion 81 and the engagement protrusion 82 come in contact with each other in the circumferential direction, and thus the two cylinder members 70 being next to each other in the axial direction thereof integrally rotate with each other.

That is, in a case where the cylinder members 71 which are positioned at the axial end portion 42b of the winding cylinder 42 rotate in response to the rotary force applied by the torsion spring 43 (in the clockwise direction in FIG. 11), the cylinder member 72 connected to the left in the vehicle width direction of the cylinder member 71 (see the right in FIG. 10) rotates while including a phase which is delayed by a dimensional difference between the engagement recessed portion 81 and the engagement protrusion 82. In addition, the cylinder members 73 to 79 which each is disposed at the left in the vehicle width direction relative to the cylinder member 72 rotates while including a phase which is delayed by a dimensional difference between the engagement recessed portion 81 and the engagement protrusion 82 relative to the cylinder members 70 which are disposed next to each other at the upper stream of the passage where the rotary force is transmitted in the axial direction. Here, the rotary phase difference Δθ between the cylinder members 70 disposed next to each other corresponds to a half of an angle corresponding to a value calculated by subtracting a circumferential-direction width d2 of the engagement protrusion 82 from a circumferential-direction width d1 of the engagement recessed portion 81 (see FIG. 6, Δθ is approximately equal to (d1−d2)/2). The roller shade device 30 of the embodiment is configured to have a torsion at the winding cylinder 42 of the cylinder member 70 based on the rotary phase difference Δθ generated between the cylinder members 70 (71 to 79) which are next to each other in the axial direction.

In consideration of this, according to the roller shade device 30 of the embodiment, as described above, the shade sheet 20 is bonded with the winding cylinder 42 in a state where the cylinder member 79 which is farthest away from the cylinder member 71 applied with the rotary force by the torsion spring 43 is inhibited from rotating relative to the fixed shaft 41 in a case where the shade sheet 20 is wound up by the winding device 21.

That is, the torsion spring 43 inhibits the axial end portion 42a from rotating, the axial end portion 42a being disposed at the left in the vehicle width direction and positioned opposite to the axial end portion 42b which is disposed at the right in the vehicle width direction and to which the torsion spring 43 applies the rotary force, and thus the winding cylinder 42 is configured such that the rotary phase difference Δθ of the cylinder members 70 (71 to 79) is constantly maintained based on the rotary force applied by the torsion spring 43 in the winding up direction. Further, the shade sheet 20 is bonded with the winding cylinder 42 in this state, and thus the direction of rotary force applied by the torsion spring 43 relative to the winding cylinder 42 does not change after the rotation prevention operation is released. Accordingly, even after the shade sheet 20 is wound up by the winding cylinder 42, the rotary phase difference Δθ may be constantly maintained between the cylinder members 70 (71 to 79) which are disposed next to each other in the axial direction based on the rotary force of the torsion spring 43 applied to the winding cylinder 42 in the winding-up direction.

That is, for example, in a case where the manufacturing method in which the rotary force based on the elastic force of the torsion spring 43 is applied to the winding cylinder 42 after the shade sheet 20 is bonded with the winding cylinder 42 which is in the unloaded state is employed, the torsion may be generated at the winding cylinder 42 in a state where the shade sheet 20 is bonded with the winding cylinder 42. Then, wrinkles may be generated at the shade sheet 20 in response to the torsion of the cylinder member 42 generated after the bonding of the shade sheet 20.

However, in a case where the winding operation of the shade sheet 20 is operated with the above operation procedure (see FIG. 7), a state where the additional torsion is unlikely to be generated at the winding cylinder 42 may be maintained even after the shade sheet 20 is wound up by the winding cylinder 42 in response to the rotary force of the torsion spring 43 applied to the winding cylinder 42 in the winding-up direction. The roller shade device 30 of the embodiment is configured to maintain the secure designability while inhibiting the shade sheet 20 from having wrinkles.

Next, the effect and advantage of the embodiment will be explained.

(1) The roller shade device 30 includes the fixed shaft 41 curved to be formed in an arc shape, the winding cylinder 42 including the flexibility, which follows the curved shape of the fixed shaft 41, the winding cylinder 42 into which the fixed shaft 41 is fittingly inserted so as to be rotatable, the shade sheet 20 being wound up around the winding cylinder 42, and the torsion spring 43 applying the rotary force for winding up the shade sheet 20 around the winding cylinder 42. In addition, in a case where the shade sheet 20 is wound up around the winding cylinder 42, the winding cylinder 42 is configured such that the axial end portion 42a which is disposed opposite to the axial end portion 42b which is connected with the torsion spring 43 is inhibited from relatively rotating with the fixed shaft 41 in a state where the torsion spring 43 applies the rotary force in the winding-up direction to the winding cylinder 42. The shade sheet 20 is attached to the winding cylinder 42 in a state where the axial end portion 42a of the winding cylinder 42 is inhibited from rotating.

According to the aforementioned configuration, the shade sheet 20 is attached to the winding cylinder 42 in a state where the winding cylinder 42 is previously twisted in response to the rotary force applied by the torsion spring 43 in the winding-up direction. As a result, even after the shade sheet 20 is wound up around the winding cylinder 42 by releasing of the rotation prevention function of the winding cylinder 42, the torsion of the winding cylinder 42 may be maintained constantly in response to the rotary force applied by the torsion spring 43 in the winding-up direction, that is, a state where the additional torsion is not likely to be generated at the winding cylinder 42 may be maintained. Accordingly, the enhanced designability may be secured by the inhibition of the generation of the wrinkles at the shade sheet 20.

(2) The winding cylinder 42 is provided with the first hole portion 91 which passes through the winding cylinder 42 in the radial direction is provided at the axial end portion 42a which is disposed opposite to the axial end portion 42b being connected with the torsion spring 43. The fixed shaft 41 is provided with the second hole portion 92 which, in the radial direction, passes through the insertion portion 53 of the first support member 51 being integrally provided with the fixed shaft 41 at the axial end portion 41a which is disposed at the left in the vehicle width direction, as is the case with the axial end portion 42a of the winding cylinder 42 including the first hole portion 91. The rotation-prevention pin 93 serving as the shaft-shaped member for rotation prevention function is inserted into the first and second hole portions 91, 92, and thus a rotation prevention mechanism 95 is formed, the rotation prevention mechanism 95 which may retain the axial end portion 42a of the winding cylinder 42 to be relatively unrotatable, the axial end portion 42a which is away, in the axial direction, from the position where the torsion spring 43 applies the rotary force.

According to the aforementioned embodiment, the axial end portion 42a of the winding cylinder 42 which is, in the axial direction, away from the axial end portion 42b which is connected with the torsion spring 43 may be easily inhibited from rotating relative to the fixed shaft 41 with the simple configuration in a state where the torsion spring 43 applies the rotary force in the winding-up direction to the winding cylinder 42. In this state, the shade sheet 20 is bonded to the winding cylinder 42, and thus the enhanced designability may be secured by the inhibition of the wrinkles of the shade sheet 20.

(3) The winding cylinder 42 is provided by connecting of plural cylinder members 70 (71 to 79) with one another in the axial direction. That is, the plural cylindrical members 70 that are connected with one another in the axial direction includes the winding cylinder 42, and thus the flexibility following the curved shape of the fixed shaft 41 may be applied to the winding cylinder 42 while securing the high support rigidity. In addition, in a case where the cylinder members 70 including the winding cylinder 42 rotate in response to the rotary force applied by the torsion spring 43, the cylinder members 70 rotate with the phase which is delayed by the predetermined rotary phase difference Δθ based on the connection structure of the cylinder members 70 including the flexibility as a winding cylinder 42, sequentially from the upstream to the downstream of the passage where the rotary force is transmitted in the axial direction. Thus, by employing the aforementioned configuration of (1) to the winding cylinder 42, the rotary phase difference Δθ of the cylinder members 70 which are disposed next to each other in the axial direction may be maintained constantly in response to the rotary force applied by the torsion spring 43 in the winding-up direction around the winding cylinder 42. Accordingly, after the shade sheet 20 is bonded to the winding cylinder 42, the state where the additional torsion is unlikely generated at the winding cylinder 42 may be maintained.

The aforementioned embodiment may be modified as follows. The aforementioned embodiment and modified examples may be combined as long as it does not contradict technically.

According to the aforementioned embodiment, the lighting portion 3 is provided such that the roof opening portion 4 is provided with the translucent panel 5 which is movable. Alternatively, the lighting portion 3 may be provided such that the translucent panel 5 is fixed to the roof panel opening portion 4. A non-translucent movable panel may be provided at the roof opening portion 4.

The position of the lighting portion 3 being attached with the roller shade device 30 does not necessarily have to be provided at the roof opening portion 4, and may be provided at a position where the sunshade device 11 is required. For example, a position may correspond to, for example, a side window of the side of the vehicle.

In the aforementioned embodiment, the fixed shaft 41 which is previously curved to be formed in an arc shape is employed. Alternatively, the fixed shaft 41 may be curved to match a curved shape of a position where the fixed shaft 41 is disposed.

According to the embodiment, the torsion spring 43 is configured such that the first end portion 43a is locked by the axial protrusion 61 which is disposed at the first support member 51 integrally provided with the fixed shaft 41, and the second end portion 43b is locked by the axial protrusion 62 which is provided at the connection member 56 integrally provided with the winding cylinder 42. Alternatively, the first end portion 43a and the second end portion 43b of the torsion spring 43 may be directly connected to the fixed shaft 41 and the winding cylinder 42, respectively, which serve as connection targets.

According to the aforementioned embodiment, the second end portion 43b of the torsion spring 43 is connected to the winding cylinder 42 at the axial end portion 42b which is disposed at the right in the vehicle width direction. Alternatively, for example, the connected position does not necessarily have to be at an axial end portion of the torsion spring 43, and may be provided at, for example, a center portion in the axial direction. For example, in a case where the axial-direction center portion of the winding cylinder 42 corresponds to a connected position of the torsion spring 43, the axial end portion 42b which is disposed at the right in the vehicle-width direction also corresponds to an axial end portion which is away from a position where the torsion spring 43 is connected in the axial direction. Thus, in this case, as is the case with the axial end portion 42a which is disposed at the right in the vehicle-width direction, the axial end portion 42b which is disposed at the right in the vehicle-width direction may be inhibited from rotating relative to the fixed shaft 41.

In addition, the axial end portion 41a of the fixed shaft 41 does not necessarily have to be the portion connected to the first end portion 43a of the torsion spring 43. The plural torsion springs 43 may be employed to apply the rotary force in the winding-up direction to the winding cylinder 42.

According to the aforementioned embodiment, the rotation-prevention pin 93 serving as a shaft-shaped member for the rotation prevention function is inserted into the first hole portions 91 passing through the axial end portion 42a of the winding cylinder 42, and the second hole portions 92 passing through, in the radial direction, the insertion portion 53 of the first support member 51 which is integrally provided with the axial end portion 41a of the fixed shaft 41 to include the rotation prevention mechanism 95 (see FIG. 9).

Alternatively, for example, as shown in FIG. 12, the rotation-prevention pin 93 may be inserted into a first hole portion 91B which is provided at a winding cylinder 42B and a second hole portion 92B provided at a first support member 51B which is integrally provided with the fixed shaft 41 from the axial direction of the winding cylinder 42B, and thus the rotation prevention mechanism 95 may be provided. In a case where this configuration is employed, a flange portion 97 for including the first hole portion 91B at the axial end portion 42a of the winding cylinder 42B may be provided.

The rotation prevention mechanism 95 may lock the fixed shaft 41 directly. Then, for example, the rotation prevention mechanism 95 may include other configurations, for example, protrusions for rotation-prevention function which are provided at the fixed shaft 41 and the winding cylinder 42 may be integrally restrained, or attached.

According to the aforementioned embodiment, the plural cylinder members 70 (71 to 79) are connected with one another in the axial direction to include the winding cylinder 42. Alternatively, the number of the cylinder members 70 included by the winding cylinder 42 and the form of the connection portion may be freely changed.

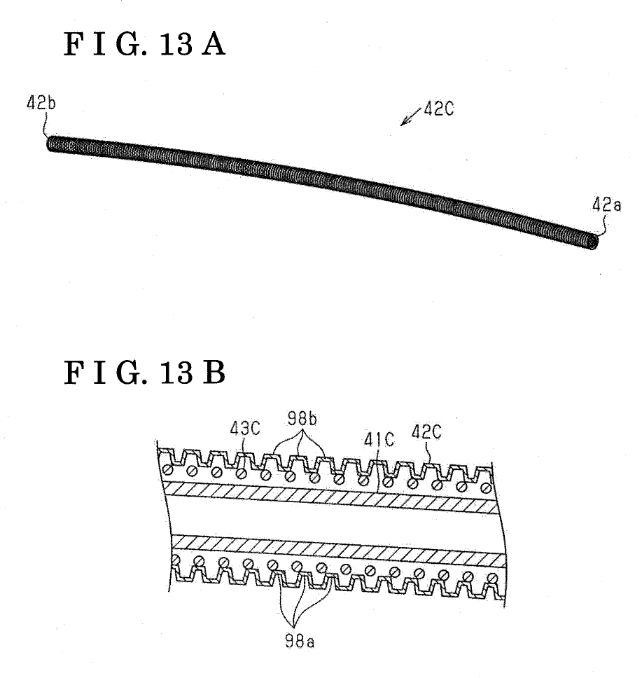

For example, as illustrated in FIGS. 13A and 13B, the configuration of the winding cylinder 42 may be freely changed as long as the winding cylinder 42 includes a configuration which includes the flexibility following the curved shape of the fixed shaft 41 and within which the fixed shaft 41 is inserted to be positioned so as to be rotatable therewith, for example, the winding cylinder 42C including the corrugated structure in which small diameter portions 98a and large diameter portions 98b are continuously and alternatively provided. As illustrated in FIG. 13B, the torsion spring 43C may be fitted onto the outer circumference of the fixed shaft 41.

Next, the technical idea which may be comprehended by the above embodiment and the modified examples will hereunder be explained.

The roller shade device which is characterized in that the shaft-shaped member for rotation prevention function is inserted into the first and second hole portions in the radial direction of the winding cylinder and the fixed shaft.

The roller shade device which is characterized in that the shaft-shaped member for rotation prevention function is inserted into the first and second hole portions in the axial direction of the winding cylinder and the fixed shaft.

The roller shade device which is characterized in that the winding cylinder includes the corrugated structure in which the small diameter portions and the large diameter portions are continuously and alternatively provided. Accordingly, the structure of the cylinder which includes the flexibility following the curved shape of the fixed shaft and within which the fixed shaft is inserted to be positioned so as to be rotatable therewith may be secured.

According to the aforementioned embodiment, the manufacturing method of a roller shade device (30) including a fixed shaft (41), a winding cylinder (42) which has flexibility following a curved shape of the fixed shaft (41), and within which the fixed shaft (41) is inserted to be positioned so as to be rotatable therewith, a shade sheet (20) which is wound up around the winding cylinder (42), and a torsion spring (43) applying a rotary force to the winding cylinder (42), the rotary force which winds up the shade sheet (20) around the winding cylinder (42) includes a process of inhibiting an axial end portion (42a) of the winding cylinder (42) from rotating relative to the fixed shaft (41) in a state where the torsion spring (43) applies the rotary force to the winding cylinder (42), the axial end portion (42a) being away in an axial direction from a position where the torsion spring (43) is connected to the winding cylinder (42), and a process of bonding the shade sheet (20) to the winding cylinder (42) in a state where the axial end portion (42a) is inhibited from rotating.

According to the aforementioned configuration, the shade sheet 20 is attached to the winding cylinder 42 in a state where the winding cylinder 42 is previously twisted in response to the rotary force applied by the torsion spring 43 in the winding-up direction. As a result, even after the shade sheet 20 is wound up around the winding cylinder 42 by releasing of the rotation prevention function of the winding cylinder 42, the torsion of the winding cylinder 42 may be maintained constantly in response to the rotary force applied by the torsion spring 43 in the winding-up direction, that is, a state where the additional torsion is not likely to be generated at the winding cylinder 42 may be maintained. Accordingly, the enhanced designability may be secured by the inhibition of the generation of the wrinkles at the shade sheet 20.

According to the aforementioned embodiment, the process of inhibiting the axial end portion (42b) of the winding cylinder (42) from rotating includes a process of inserting a shaft-shaped member (93) for rotation prevention function into a first hole portion (91, 91B) being provided at the winding cylinder (42) and into a second hole portion (92, 92B) being provided at the fixed shaft (41).

According to the aforementioned embodiment, the axial end portion 42a of the winding cylinder 42 which is, in the axial direction, away from the axial end portion 42b which is connected with the torsion spring 43 may be easily inhibited from rotating relative to the fixed shaft 41 with the simple configuration in a state where the torsion spring 43 applies the rotary force in the winding-up direction to the winding cylinder 42.

According to the aforementioned embodiment, the roller shade device (30) includes the fixed shaft (41), the winding cylinder (42) which has flexibility following the curved shape of the fixed shaft (41), and within which the fixed shaft (41) is inserted to be positioned so as to be rotatable therewith, the shade sheet (20) which is wound up around the winding cylinder (42), the torsion spring (43) applying a rotary force to the winding cylinder (42), the rotary force which winds up the shade sheet (20) around the winding cylinder (42), and the rotation prevention mechanism (95) inhibiting an axial end portion (42a) of the winding cylinder (42) from rotating relative to the fixed shaft (41) in a state where the torsion spring (43) applies the rotary force to the winding cylinder (42), the axial end portion (42a) being away in an axial direction from a position where the torsion spring (43) is connected to the winding cylinder (42).

According to the aforementioned embodiment, the axial end portion 42a of the winding cylinder 42 which is, in the axial direction, away from the axial end portion 42b which is connected with the torsion spring 43 may be easily inhibited from rotating relative to the fixed shaft 41 with the simple configuration in a state where the torsion spring 43 applies the rotary force in the winding-up direction to the winding cylinder 42. In this state, the shade sheet 20 is bonded to the winding cylinder 42, and thus the enhanced designability may be secured by the inhibition of the wrinkles of the shade sheet 20.

According to the aforementioned embodiment, the rotation prevention mechanism (95) includes the first hole portion (91, 91B) being provided at the winding cylinder (42), the second hole portion (92, 92B) being provided at the fixed shaft (41), and the shaft-shaped member (93) for rotation prevention function being inserted into the first hole portion (91, 91B) and the second hole portion (92, 92B).

According to the aforementioned configuration, the rotation-prevention mechanism of the winding cylinder 42 may be easily provided with the simple configuration.

According to the aforementioned embodiment, the winding cylinder (42) is formed by a plurality of cylinder members (70, 71, 72, 73, 74, 75, 76, 78, 79) being connected with one another in the axial direction.

That is, the plural cylindrical members 70 that are connected with one another in the axial direction includes the winding cylinder 42, and thus the flexibility following the curved shape of the fixed shaft 41 may be applied to the winding cylinder 42 while securing the high support rigidity. In addition, in a case where the cylinder members 70 including the winding cylinder 42 rotate in response to the rotary force applied by the torsion spring 43, the cylinder members 70 rotate with the phase which is delayed by the predetermined rotary phase difference Δθ based on the connection structure of the cylinder members 70 including the flexibility as a winding cylinder 42, sequentially from the upstream to the downstream of the passage where the rotary force is transmitted in the axial direction. Thus, by employing the aforementioned configuration of (1) to the winding cylinder 42, the rotary phase difference Δθ of the cylinder members 70 which are disposed next to each other in the axial direction may be maintained constantly in response to the rotary force applied by the torsion spring 43 in the winding-up direction around the winding cylinder 42. Accordingly, after the shade sheet 20 is bonded to the winding cylinder 42, the state where the additional torsion is unlikely generated at the winding cylinder 42 may be maintained.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A manufacturing method of a roller shade device including a fixed shaft, a winding cylinder which has flexibility following a curved shape of the fixed shaft, and within which the fixed shaft is inserted to be positioned so as to be rotatable therewith, a shade sheet which is wound up around the winding cylinder, and a torsion spring applying a rotary force to the winding cylinder, the rotary force which winds up the shade sheet around the winding cylinder, comprising:
a process of inhibiting an axial end portion of the winding cylinder from rotating relative to the fixed shaft in a state where the torsion spring applies the rotary force to the winding cylinder, the axial end portion being away in an axial direction from a position where the torsion spring is connected to the winding cylinder; and
a process of bonding the shade sheet to the winding cylinder in a state where the axial end portion is inhibited from rotating.

2. The manufacturing method of the roller shade device according to claim 1, wherein the process of inhibiting the axial end portion of the winding cylinder from rotating includes a process of inserting a shaft-shaped member for rotation prevention function into a first hole portion being provided at the winding cylinder and into a second hole portion being provided at the fixed shaft.

3. A roller shade device comprising:
a fixed shaft;
a winding cylinder which has flexibility following a curved shape of the fixed shaft, and within which the fixed shaft is inserted to be positioned so as to be rotatable therewith;
a shade sheet which is wound up around the winding cylinder;
a torsion spring applying a rotary force to the winding cylinder, the rotary force which winds up the shade sheet around the winding cylinder; and
a rotation prevention mechanism inhibiting an axial end portion of the winding cylinder from rotating relative to the fixed shaft in a state where the torsion spring applies the rotary force to the winding cylinder, the axial end portion being away in an axial direction from a position where the torsion spring is connected to the winding cylinder.

4. The roller shade device according to claim 3, wherein the rotation prevention mechanism includes:
a first hole portion being provided at the winding cylinder;
a second hole portion being provided at the fixed shaft; and
a shaft-shaped member for rotation prevention function being inserted into the first hole portion and the second hole portion.

5. The roller shade device according to claim 3, wherein the winding cylinder is formed by a plurality of cylinder members being connected with one another in the axial direction.

6. The roller shade device according to claim 4, wherein the winding cylinder is formed by a plurality of cylinder members being connected with one another in the axial direction.
